(19) United States
(12) Patent Application Publication
(10) Pub. No.: US 2026/0155486 A1
(43) Pub. Date: Jun. 4, 2026

(54) Battery Module and Energy Storage System

(71) Applicant: SK On Co., Ltd., Seoul (KR)

(72) Inventors: Dong Jun LIM, Daejeon (KR); Hyun Jun KO, Daejeon (KR); Hong Sik KIM, Daejeon (KR); Moo Han BAEK, Daejeon (KR)

(21) Appl. No.: 19/407,118

(22) Filed: Dec. 3, 2025

(30) Foreign Application Priority Data
Dec. 4, 2024 (KR) 10-2024-0178909
Sep. 4, 2025 (KR) 10-2025-0126069

(51) Int. Cl. H01M 10/6568; H01M 10/48; H01M 10/613; H01M 50/325

(52) U.S. Cl. CPC H01M 10/6568; H01M 10/486; H01M 10/613; H01M 50/325

(57) ABSTRACT

The present disclosure relates to a battery module including: a case having an internal receiving space for housing a plurality of battery assemblies; a cooling assembly disposed in the case and including a cooling path through which a cooling fluid for cooling the plurality of battery assemblies flows; a fire-extinguishing path including one end connected to the cooling path and the other end disposed in the internal receiving space; a passive valve disposed at the other end of the fire-extinguishing path and configured to open and close the fire-extinguishing path; an active valve disposed between one end of the fire-extinguishing path and the passive valve and configured to open and close the fire-extinguishing path; and a module control unit configured to control the operation of the active valve.

### CROSS-REFERENCE TO RELATED APPLICATION AND CLAIM OF PRIORITY

This application claims priority to Korean Patent Application No. 10-2024-0178909 filed on Dec. 4, 2024 and No. 10-2025-0126069 filed on Sep. 4, 2025 in the Korean Intellectual Property Office (KIPO), the entire disclosure of which is incorporated by reference herein.

### TECHNICAL FIELD

The present disclosure relates to a battery module and an energy storage system.

### BACKGROUND

The usage and application of energy storage systems (ESS) are rapidly increasing, and their storage capacities are becoming larger. These large-scale energy storage systems use a battery module including a plurality of battery cells that are electrically connected to each other, and a battery pack in which the battery modules are connected as unit modules.

The battery cells constituting the energy storage system can generate a large amount of heat for various reasons, such as during the charging and discharging processes, a short circuit, or exposure to high-temperature environments.

If the generated heat is not effectively removed, it may accumulate inside the system, causing degradation in the performance of the energy storage system and potentially leading to safety hazards such as fire or explosion.

### SUMMARY

According to various embodiments of the present disclosure, a battery module and an energy storage system capable of preventing fire propagation are provided.

A battery module according to one embodiment of the present disclosure may include: a case having an internal receiving space for housing a plurality of battery assemblies; ; a cooling assembly disposed in the case and including a cooling path through which a cooling fluid for cooling the plurality of battery assemblies flows; a fire-extinguishing path including one end connected to the cooling path and the other end disposed in the internal receiving space; a passive valve disposed at the other end of the fire-extinguishing path and configured to open and close the fire-extinguishing path; an active valve disposed between one end of the fire-extinguishing path and the passive valve and configured to open and close the fire-extinguishing path; and a module control unit configured to control the operation of the active valve.

In one embodiment, the battery module may further include sensor unit configured to detect a normal or abnormal state of the battery assembly.

In one embodiment, the sensor unit may include a temperature sensor configured to measure a temperature of the battery assembly.

In one embodiment, wherein the module control unit opens the active valve when the temperature of the battery assembly is outside a normal range.

In one embodiment, the sensor unit may include a voltage sensor configured to measure a voltage of the battery assembly.

In one embodiment, wherein the module control unit opens the active valve when the voltage of the battery assembly deviates from a reference value.

In one embodiment, wherein, when the battery assembly is determined to be in an abnormal state, the module control unit operates the active valve to direct the cooling fluid into the fire-extinguishing path.

In one embodiment, wherein, when the battery assembly is in a normal state, the module control unit maintains the active valve closed so that the cooling fluid flows through the cooling path.

In one embodiment, when the temperature of the battery assembly reaches or exceeds a reference temperature, the passive valve may be opened.

In one embodiment, when both the active valve and the passive valve are opened, the cooling fluid flowing through the fire-extinguishing path may be introduced into the internal receiving space.

In one embodiment, when the cooling fluid is introduced into the internal receiving space, the plurality of battery assemblies may be immersed in the cooling fluid.

In one embodiment, the case may include a gas venting part formed therein through which gas generated in the internal receiving space is discharged.

An energy storage system according to one embodiment of the present disclosure may include: a battery rack; a plurality of battery modules disposed in the battery rack; and a system control unit configured to control the plurality of battery modules, wherein each of the plurality of battery modules may include: a case having an internal receiving space for housing a plurality of battery assemblies; a cooling assembly positioned within the case and including a cooling path through which a cooling fluid flows; a fire-extinguishing path having one end connected to the cooling path and another end disposed in the internal receiving space; a passive valve disposed at said other end of the fire-extinguishing path and configured to selectively open or close the fire-extinguishing path; an active valve located between said one end of the fire-extinguishing path and the passive valve, and configured to selectively open or close the fire-extinguishing path; and a module control unit configured to control operation of the active valve.

In one embodiment, wherein the battery module further comprises a sensor unit configured to detect whether the battery assembly is in a normal or abnormal state.

In one embodiment, wherein the sensor unit comprises a temperature sensor configured to measure the temperature of the battery assembly.

In one embodiment, wherein the module control unit opens the active valve when the battery assembly is determined to be in an abnormal state.

In one embodiment, wherein the module control unit determines the battery assembly is in an abnormal state when the temperature exceeds a reference temperature.

In one embodiment, when the temperature of the battery assembly reaches or exceeds the reference temperature, the passive valve may be opened.

In one embodiment, wherein, when any of the battery assemblies is detected to be in an abnormal state, the system control unit operates the module control unit to open the active valve connected to the corresponding battery assembly.

In one embodiment, when both the active valve and the passive valve are opened, the cooling fluid flowing through the fire-extinguishing path may be introduced into the internal receiving space, thereby immersing the plurality of battery assemblies in the cooling fluid.

According to various embodiments of the present disclosure, fire propagation in the battery module and the energy storage system can be prevented by utilizing a coolant inside the battery module.

According to various embodiments of the present disclosure, thermal runaway of the battery module and the energy storage system can be prevented.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a perspective view illustrating a battery module according to one embodiment of the present disclosure;

FIG. 2 is a schematic perspective view illustrating a battery module according to one embodiment of the present disclosure;

FIG. 3 is an enlarged view of region A of FIG. 2;

FIG. 4 is a view illustrating the flow of a coolant in a normal state;

FIG. 5 is a view illustrating the flow of a coolant in an abnormal state;

FIG. 6 is a block diagram illustrating the operation of a module control unit according to one embodiment of the present disclosure;

FIG. 7 is a flowchart illustrating the operation of the battery module according to one embodiment of the present disclosure;

FIG. 8 is a schematic perspective view illustrating an energy storage system according to one embodiment of the present disclosure; and

FIG. 9 is a block diagram illustrating the operation of a system control unit according to one embodiment of the present disclosure.

### DETAILED DESCRIPTION OF THE EMBODIMENTS

The embodiments disclosed herein are provided to enable those skilled in the art to more fully understand the present disclosure. The following embodiments may be modified in various forms, and the scope of the present disclosure is not limited to these embodiments.

Hereinafter, some embodiments of the present disclosure will be described through exemplary drawings for the convenience of description. When assigning reference numerals to components of the respective drawings, it should be noted that the same components will be denoted by the same reference numerals, even if they appear in different drawings.

The terms or words used in the present specification and claims should not be interpreted as being limited to their conventional or lexical meanings. Rather, they should be construed based on the meanings and concepts consistent with the technical concept of the present disclosure, according to the principle that a person who drafted the disclosure may define the terms or words in the most appropriate manner to describe the disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, these terms should be construed to imply that the presence of the corresponding component, and not to exclude but rather include other components.

In addition, in describing components of the embodiment of the present disclosure, the terms such as first, second, A, B, (a), (b), and the like may be used. These terms are used to distinguish the component from other components and do not impose any limitations on their nature, sequence or order, etc.

It will be understood that when a component is described as being “connected” or “coupled” to another component, the component may be directly connected or coupled to the other component, but it may be “connected” or “coupled” to the other component with another component possibly interposed.

Space-related terms such as “beneath,” “below,” “lower,” “above,” and “upper” may be used to aid in the understanding of the relationship between an element or feature and another illustrated in the drawings. These space-related terms are provided to aid in the understanding of the present disclosure in various processing or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” as well as “below” depending on orientation.

The embodiments described in this specification and the configurations illustrated in the drawings merely represent the most preferred embodiments of the present disclosure but do not encompass all aspects of the technical spirit of the present disclosure. Thus, it should be understood that various modifications and equivalents may be implemented at the time of filing the present application. In addition, the publicly known functions and configurations that are deemed unnecessary for clarifying the essence of the present disclosure will not be described.

In this specification, an XYZ coordinate system may be used. For example, the XYZ coordinate system may include an X-axis, a Y-axis, and a Z-axis. The XYZ coordinate system as described herein shall refer to a Cartesian coordinate system, unless otherwise specified.

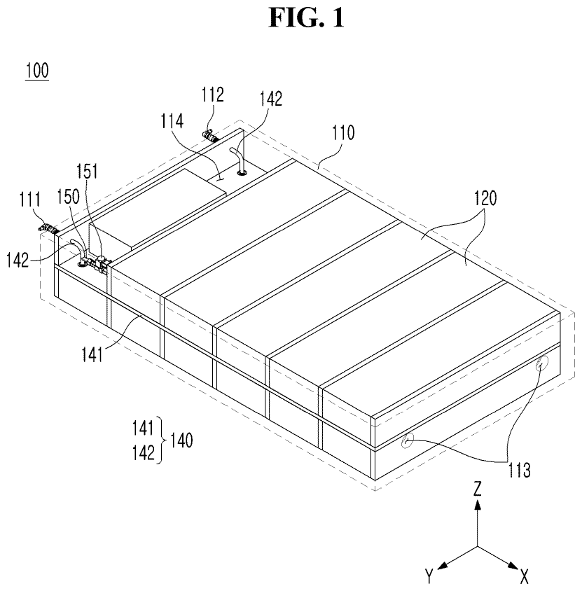

In this specification, the front-back direction, left-right direction, and up-down direction may be set based on FIG. 1. The front-back direction may be parallel to the X-axis. For example, a positive X-axis direction may represent the frontward direction, and a negative X-axis direction may represent the rearward direction.

The left-right direction may be parallel to the Y-axis. For example, a positive Y-axis direction may represent a leftward direction. A negative Y-axis direction may represent a rightward direction.

The up-down direction may be parallel to the Z-axis. For example, a positive Z-axis direction may represent an upward direction. For example, a negative Z-axis direction may represent a downward direction.

However, if the orientation of the corresponding object changes, the direction may be expressed differently.

Hereinafter, a battery module 100 according to various embodiments of the present disclosure will be described in detail with reference to the accompanying drawings.

Referring to FIGS. 1 to 6, the battery module 100 may include a case 110, a battery assembly 120, a cooling assembly 140, a fire-extinguishing path 150, and a module control unit 160.

The case 110 may protect components accommodated therein from external impacts or contamination. An internal receiving space 114 may be formed inside the case 110.

The case 110 may include a gas venting part 113 formed therein to discharge gas generated in the internal receiving space 114. If the temperature of the battery assembly 120 increases and gas is generated, the gas may be discharged outside the battery module 100 through the gas venting part 113.

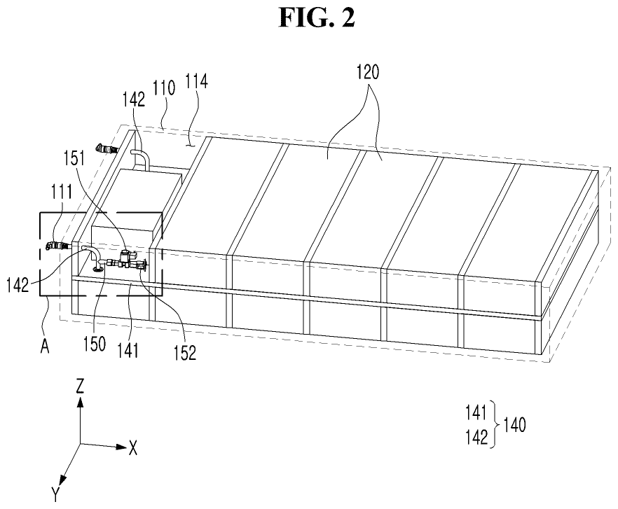

Referring to FIG. 2, the internal receiving space 114 may accommodate the cooling assembly 140, the fire-extinguishing path 150, and a plurality of battery assemblies 120.

The plurality of battery assemblies 120 may be arranged in the front-back direction. The plurality of battery assemblies 120 may be arranged in the up-down direction. The fire-extinguishing path 150 may be arranged at one end of the case 110 in the front-back direction. The fire-extinguishing path 150 may be arranged at the upper or lower portion of the case 110. The fire-extinguishing path 150 may be arranged at the front or rear of the case 110.

The battery assembly 120 may include a plurality of battery cells (not shown), a bus bar assembly (not shown), and a sensing unit (not shown).

The battery cells may be conventional battery cells capable of converting the chemical energy of materials stored in an electrode assembly into electrical energy. The battery cells described in the present disclosure may be conventional battery cells capable of performing multiple charge and discharge cycles.

The bus bar assembly may include a bus bar (not shown) and a bus bar plate (not shown). The bus bar may electrically connect electrode leads of the plurality of battery cells.

The bus bar plate may be a plate on which the bus bar may be mounted.

The sensing unit may be a sensing member that detects the state of the battery cell.

Since the battery cell, the bus bar assembly, and the sensing unit are known in the art, a detailed description thereof will be omitted.

The battery assembly 120 may have various shapes, such as a cylindrical, prismatic, or pouch types.

The cooling assembly 140 may be disposed in the case 110. A cooling fluid C may flow inside the cooling assembly 140.

The cooling fluid C may cool the plurality of battery assemblies 120. The cooling fluid C may be coolant or cooling oil.

The case 110 may include a cooling fluid inlet 111 and a cooling fluid outlet 112 formed therein. The cooling fluid inlet 111 and the cooling fluid outlet 112 may be formed spaced apart from each other on one side of the case 110. The cooling fluid inlet 111 may be formed on one side of the case 110, and the cooling fluid outlet 112 may be formed on the other side of the case 110.

The cooling assembly 140 may be in communication with the cooling fluid inlet 111 and the cooling fluid outlet 112. The cooling fluid C may flow into the cooling assembly 140 through the cooling fluid inlet 111. The cooling fluid C introduced into the cooling assembly 140 may be discharged outside the case 110 through the cooling fluid outlet 112.

The cooling assembly 140 may include a cooling plate 141 and a cooling path 142.

The cooling plate 141 may be disposed on one side of the battery assembly 120. If the plurality of battery assemblies 120 are arranged in the up-down direction, the cooling plate 141 may be disposed between the battery assemblies 120 in the up-down direction. If the plurality of battery assemblies 120 are arranged in the front-back direction, the cooling plate 141 may be disposed between the battery assemblies 120 in the front-back direction.

The cooling fluid C may flow inside the cooling plate 141.

The cooling path 142 may connect the cooling plate 141 and the case 110 in communication therewith. A plurality of cooling paths 142 may be provided. Some of the cooling paths 142 may connect the cooling fluid inlet 111 and the cooling plate 141. Other cooling paths 142 may connect the cooling fluid outlet 112 and the cooling plate 141. Still other cooling paths 142 may connect the cooling plates 141 to each other. When a plurality of cooling plates 141 are disposed inside the case 110, the cooling path 142 may connect the plurality of cooling plates 141 to each other. Alternatively, one cooling path 142 may connect the cooling fluid inlet 111 and the cooling plate 141, and may also connect the cooling plate 141 and the cooling fluid outlet 112.

As long as the cooling path 142 connects the cooling plate 141 and the case 110, and connects each cooling plate 141 to one another, the number and shape of the cooling paths 142 are not particularly limited.

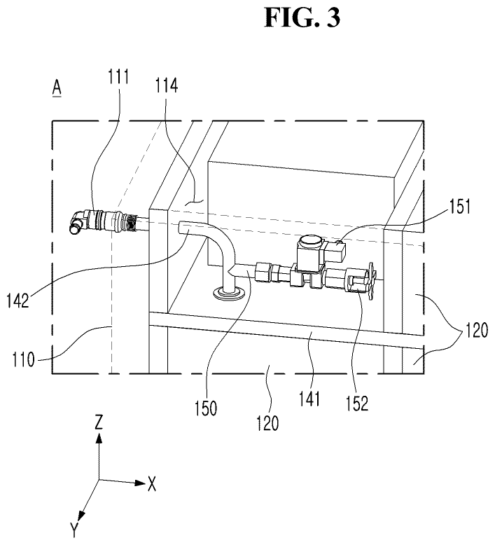

Referring to FIG. 3, the fire-extinguishing path 150 may be in communication with the cooling assembly 140.

One end of the fire-extinguishing path 150 may be connected to the cooling assembly 140, and the other end may be disposed in the internal receiving space 114.

An active valve 151 and a passive valve 152 may be installed in the fire-extinguishing path 150. For example, the active valve 151 may be a solenoid valve. The active valve 151 may be opened and closed by the module control unit 160.

The passive valve 152 may be opened if the temperature of the battery assembly 120 reaches or exceeds a reference temperature. The passive valve 152 may be closed when the temperature of the battery assembly 120 is at or below the reference temperature. For example, the reference temperature may be 70° C. For example, the passive valve 152 may be a temperature-sensitive valve. For example, the passive valve 152 may be a wax valve or a temperature-responsive valve.

The active valve 151 may be disposed between the cooling assembly 140 and the passive valve 152. For example, the active valve 151 may be connected to the cooling path 142, and the passive valve 152 may be connected to the active valve 151.

The cooling fluid introduced into the case 110 through the cooling fluid inlet 111 may flow from the active valve 151 toward the passive valve 152.

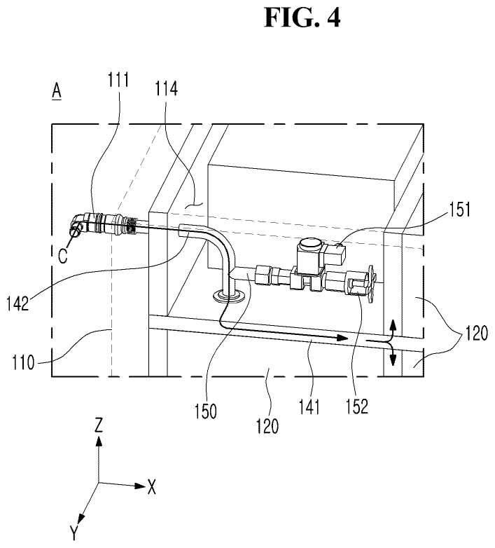

Referring to FIG. 4, when the battery assembly 120 is in a normal state, the other end of the fire-extinguishing path 150 may be maintained in a closed state by the active valve 151 and the passive valve 152. Therefore, the cooling fluid C may be introduced through the cooling fluid inlet 111 and flow inside the cooling assembly 140. The cooling fluid C may cool the battery assembly 120.

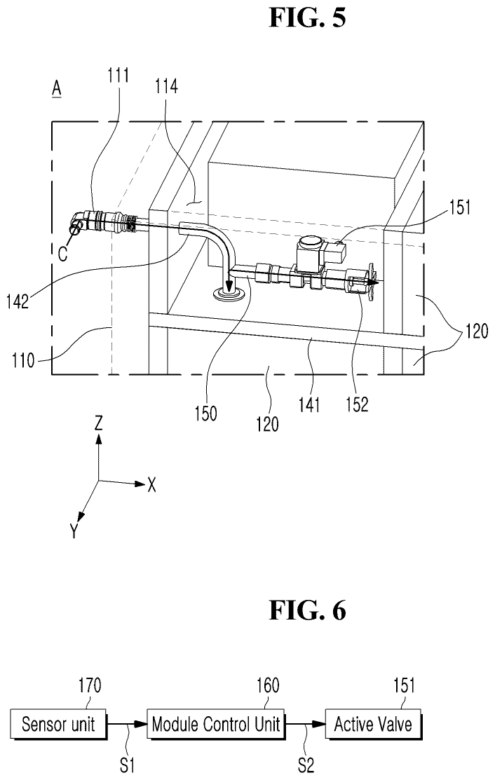

Referring to FIG. 5, when the battery assembly 120 is in an abnormal state, the active valve 151 may be opened by the module control unit 160. When the temperature of the battery assembly 120 reaches or exceeds the reference temperature, the passive valve 152 may be opened. When both the active valve 151 and the passive valve 152 are opened, the other end of the fire-extinguishing path 150 may be opened. The cooling fluid C introduced through the cooling fluid inlet 111 may flow into the fire-extinguishing path 150. Although not shown in the drawings, a portion of the cooling fluid C may flow into the cooling assembly 140.

The cooling fluid C introduced into the fire-extinguishing path 150 may be introduced into the internal receiving space 114 inside the case 110. The plurality of battery assemblies 120 accommodated in the case 110 may be immersed in the cooling fluid C. When the battery assemblies 120 are immersed in the cooling fluid C, the battery assemblies 120 may be cooled. Details thereof will be described below.

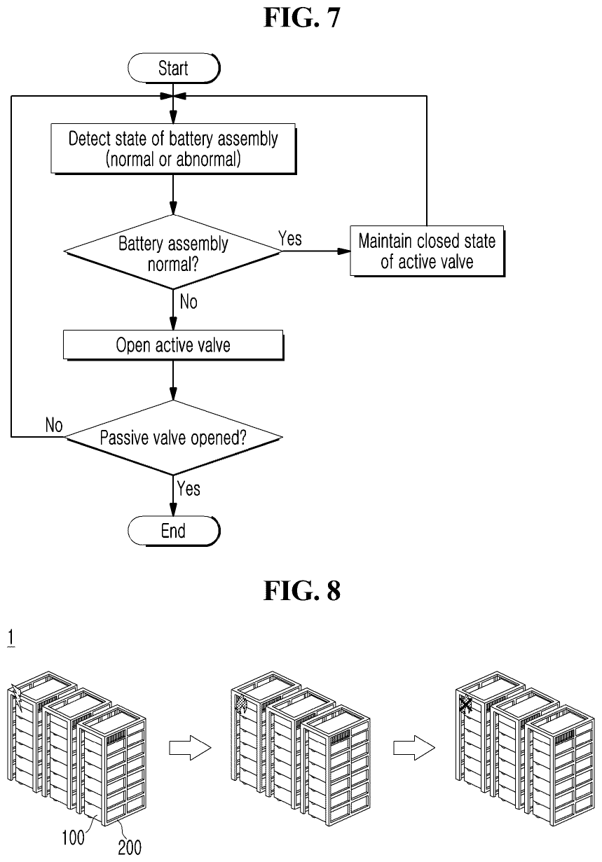

Referring to FIGS. 6 and 7, the module control unit 160 may control the operation of the active valve 151.

The module control unit 160 may include a sensor unit 170 configured to detect the state of the battery assembly 120.

The sensor unit 170 may detect the state of the battery assembly 120 to determine whether it is in a normal or abnormal state.

The module control unit 160 may receive a signal S1 from the sensor unit 170. Based on the signal S1 received from the sensor unit 170, the module control unit 160 may determine whether the battery assembly 120 is in a normal or abnormal state. The module control unit 160 may control opening or closing of the active valve 151 (S2) according to the state of the battery assembly 120.

For example, the sensor unit 170 may include a voltage sensor configured to measure the voltage of the battery assembly 120. The sensor unit 170 may measure the voltage of the battery assembly 120. When the voltage of the battery assembly 120 measured by the sensor unit 170 is lower than a reference voltage, the module control unit 160 may determine that the battery assembly 120 is in an abnormal state.

For example, the sensor unit 170 may include a temperature sensor configured to measure the temperature of the battery assembly 120. The sensor unit 170 may measure the temperature of the battery assembly 120. When the temperature of the battery assembly 120 is higher than a reference temperature, the module control unit 160 may determine that the battery assembly 120 is in an abnormal state. For example, when the temperature of the battery assembly 120 is 70° C. or higher, the module control unit 160 may determine that the battery assembly 120 is in an abnormal state.

Hereinafter, the operation of the battery module 100 will be described with reference to FIG. 7.

The active valve 151 and the passive valve 152 may be in a closed state.

The sensor unit 170 may monitor the state of the battery assembly 120. The sensor unit 170 may transmit state information of the battery assembly 120 to the module control unit 160.

When the battery assembly 120 is in a normal state, the passive valve 152 may be maintained in the closed state. If the temperature of the battery assembly 120 is at or below the reference temperature, the passive valve 152 may be closed.

The module control unit 160 may close the active valve 151. When the active valve 151 and the passive valve 152 are closed, one end of the fire-extinguishing path 150 may be closed. Therefore, the cooling fluid cannot be introduced into the internal receiving space 114 through the fire-extinguishing path 150. The cooling fluid may flow into the cooling path 142.

If the battery assembly 120 is in an abnormal state, the module control unit 160 may open the active valve 151.

For example, the active valve 151 may be a three-way valve. When the battery assembly 120 is in a normal state, the module control unit 160 may control the active valve 151 so that the cooling fluid C flows from the cooling fluid inlet 111 toward the cooling assembly 140.

If it is determined that the battery assembly 120 is in an abnormal state, the module control unit 160 may switch the opening direction of the active valve 151. The module control unit 160 may block the fire-extinguishing path toward the cooling assembly 140 and open the valve toward the other end of the fire-extinguishing path 150.

If the battery assembly 120 reaches or exceeds the reference temperature, the temperature of the cooling fluid C near the battery assembly 120 may increase. The cooling fluid C may be supplied to the cooling assembly 140 at a low temperature. The cooling plate 141 may be disposed to be in contact with the battery assembly 120, so that the cooling fluid flowing inside the cooling plate 141 may absorb heat from the battery assembly 120 to cool the battery assembly 120. Therefore, when the temperature of the battery assembly 120 increases, the temperature of the cooling fluid C near the battery assembly 120 may also increase. If the temperature of the cooling fluid C rises to or above the reference temperature, the passive valve 152 may be opened.

When both the active valve 151 and the passive valve 152 are opened, the other end of the fire-extinguishing path 150 may be opened. The cooling fluid C flowing inside the fire-extinguishing path 150 may be introduced into the internal receiving space 114. Accordingly, the battery assembly 120 disposed in the internal receiving space 114 may be immersed.

In contrast, if only the active valve 151 is opened, the passive valve 152 may not be opened, and thus one end of the fire-extinguishing path 150 may not be opened.

For example, the sensor unit 170 may measure the voltage of the battery assembly 120. If the voltage of the battery assembly 120 is at or below the reference voltage, the module control unit 160 may determine that the battery assembly 120 is in an abnormal state. In this case, the module control unit 160 may control the active valve 151 to open. However, since the temperature of the battery assembly 120 or the cooling fluid C is not at or above the reference temperature, the passive valve 152 may not be opened. Therefore, the other end of the fire-extinguishing path 150 may not be opened. The cooling fluid C may not be introduced into the internal receiving space 114 inside the case 110 through the other end of the fire-extinguishing path 150.

Alternatively, due to a malfunction of the sensor unit 170, the module control unit 160 may malfunction. If the module control unit 160 determines that the battery assembly 120 is in an abnormal state due to a malfunction of the sensor unit 170, the active valve 151 may be opened. In this case, the passive valve 152 may not be opened, preventing the cooling fluid C from being introduced into the internal receiving space 114.

Therefore, by installing both the active valve 151 and the passive valve 152 at the other end of the fire-extinguishing path 150, the other end of the fire-extinguishing path 150 may not be opened in an abnormal state of the battery assembly 120 other than an event such as a fire or thermal runaway.

In this way, if only the active valve 151 is opened and the passive valve 152 is not opened, the cooling fluid C may not be introduced into the internal receiving space 114. The battery assembly 120 may not be immersed in the cooling fluid C. The sensor unit 170 may monitor the state of the battery assembly 120. Until both the active valve 151 and the passive valve 152 are opened, the sensor unit 170 may monitor the state of the battery assembly 120 and transmit a signal to the module control unit 160.

When the temperature of the battery assembly 120 or the cooling fluid C rises to or above the reference temperature, the module control unit 160 may open the active valve 151. Alternatively, some of the active valves 151 may be opened and some may be closed to divert the flow path of the cooling fluid C. The module control unit 160 may control the active valve 151 so that the cooling fluid C flows toward the other end of the fire-extinguishing path 150 and not toward the cooling plate 141. At this time, the passive valve 152 may also be opened due to the temperature of the cooling fluid C. When both the active valve 151 and the passive valve 152 are opened in this way, the cooling fluid C may be introduced into the internal receiving space 114. The battery assembly 120, whose temperature has risen, may be immersed in the cooling fluid C, thereby decreasing its temperature. Therefore, fire propagation or thermal runaway may be prevented.

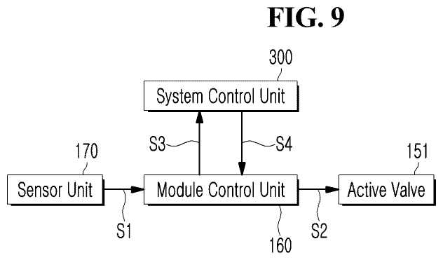

Referring to FIGS. 8 and 9, an energy storage system (ESS) 1 may include a battery rack 200, the battery modules 100, and a system control unit 300.

The energy storage system 1 may store electrical energy supplied from an external power source in the battery module and supply the stored electrical energy to an external device as needed.

The battery rack 200 may accommodate and secure the battery module 100. The battery rack 200 may include a metal material. The battery rack 200 may be formed by connecting frames.

Since the battery module 100 has been described above, a detailed description thereof will be omitted.

The system control unit 300 may control a plurality of module control units 160. The system control unit 300 may include a battery management system (BMS). The system control unit 300 may be communicatively connected to the plurality of module control units 160. The module control unit 160 may transmit a signal S3 to the system control unit 300 and receive a signal S4 from the system control unit 300. The system control unit 300 may receive information such as voltage, temperature, and state of charge (SoC) of the battery assembly 120 from each module control unit 160. The system control unit 300 may transmit a signal S4 to the module control unit 160 to control the operation of each battery module 100 based on the received information.

Referring to FIG. 8, some of the battery modules 100 in the energy storage system 1 may overheat or catch fire. In this case, the module control unit 160 of the corresponding battery module 100 may determine that the battery module 100 is in an abnormal state and transmit a signal S3 to the system control unit 300. The system control unit 300 may then transmit a signal S4 to the corresponding module control unit 160 so that the active valve 151 of the corresponding battery module 100 is opened. When the battery module 100 overheats or catches fire, the temperature of the battery assembly 120 or the nearby cooling fluid C may increase, thereby causing the passive valve 152 to open.

The system control unit 300 may control the opening of only the active valve 151 through the module control unit 160 corresponding to the battery module 100 that has overheated or caught fire. The active valve 151 of other battery modules 100, excluding the battery module 100 that has overheated or caught fire, may not be opened. Therefore, only the battery module 100 that has overheated or caught fire may be immersed in the cooling fluid C. If a fire occurs in some of the battery modules 100, heat transfer may be prevented without spraying an extinguishing fluid from the outside.

Furthermore, damage to the energy storage system 1 may be minimized by replacing only some of the battery modules 100 in the energy storage system 1.

While the preferred embodiments of the present disclosure have been described in detail above, it should be understood that the scope of the present disclosure is not limited thereto. Various modifications and improvements made by those skilled in the art based on the basic concepts of the present disclosure defined in the following claims also fall within the scope of the present disclosure.

What is claimed is:

1. A battery module comprising:
a case having an internal receiving space for housing a plurality of battery assemblies;
a cooling assembly disposed in the case and including a cooling path through which a cooling fluid for cooling the plurality of battery assemblies flows;
a fire-extinguishing path including one end connected to the cooling path and the other end disposed in the internal receiving space;
a passive valve disposed at the other end of the fire-extinguishing path and configured to open and close the fire-extinguishing path;
an active valve disposed between one end of the fire-extinguishing path and the passive valve and configured to open and close the fire-extinguishing path; and
a module control unit configured to control the operation of the active valve.

2. The battery module according to claim 1, further comprising a sensor unit configured to detect a normal or abnormal state of the battery assembly.

3. The battery module according to claim 2, wherein the sensor unit includes a temperature sensor configured to measure a temperature of the battery assembly.

4. The battery module according to claim 3, wherein the module control unit opens the active valve when the temperature of the battery assembly is outside a normal range.

5. The battery module according to claim 4, wherein the sensor unit includes a voltage sensor configured to measure a voltage of the battery assembly.

6. The battery module according to claim 5, wherein the module control unit opens the active valve when the voltage of the battery assembly deviates from a reference value.

7. The battery module according to claim 2, wherein, when the battery assembly is determined to be in an abnormal state, the module control unit operates the active valve to direct the cooling fluid into the fire-extinguishing path.

8. The battery module according to claim 2, wherein, when the battery assembly is in a normal state, the module control unit maintains the active valve closed so that the cooling fluid flows through the cooling path.

9. The battery module according to claim 1, wherein, when the temperature of the battery assembly reaches or exceeds a reference temperature, the passive valve is opened.

10. The battery module according to claim 1, wherein, when both the active valve and the passive valve are opened, the cooling fluid flowing through the fire-extinguishing path is introduced into the internal receiving space.

11. The battery module according to claim 10, wherein, when the cooling fluid is introduced into the internal receiving space, the plurality of battery assemblies are immersed in the cooling fluid.

12. The battery module according to claim 1, wherein the case includes a gas venting part formed therein through which gas generated in the internal receiving space is discharged.

13. An energy storage system comprising:
a battery rack;
a plurality of battery modules disposed in the battery rack; and
a system control unit configured to control the plurality of battery modules,
wherein each of the plurality of battery modules comprises:
a case having an internal receiving space for housing a plurality of battery assemblies;
a cooling assembly positioned within the case and including a cooling path through which a cooling fluid flows;
a fire-extinguishing path having one end connected to the cooling path and another end disposed in the internal receiving space;
a passive valve disposed at said other end of the fire-extinguishing path and configured to selectively open or close the fire-extinguishing path;
an active valve located between said one end of the fire-extinguishing path and the passive valve, and configured to selectively open or close the fire-extinguishing path; and
a module control unit configured to control operation of the active valve.

14. The energy storage system according to claim 13, wherein the battery module further comprises a sensor unit configured to detect whether the battery assembly is in a normal or abnormal state.

15. The energy storage system according to claim 14, wherein the sensor unit comprises a temperature sensor configured to measure the temperature of the battery assembly.

16. The energy storage system according to claim 14, wherein the module control unit opens the active valve when the battery assembly is determined to be in an abnormal state.

17. The energy storage system according to claim 16, wherein the module control unit determines the battery assembly is in an abnormal state when the temperature exceeds a reference temperature.

18. The energy storage system according to claim 13, wherein, when the temperature of the battery assembly reaches or exceeds the reference temperature, the passive valve is opened.

19. The energy storage system according to claim 13, wherein, when any of the battery assemblies is detected to be in an abnormal state, the system control unit operates the module control unit to open the active valve connected to the corresponding battery assembly.

20. The energy storage system according to claim 19, wherein, when both the active valve and the passive valve are opened, the cooling fluid flowing through the fire-extinguishing path is introduced into the internal receiving space, thereby immersing the plurality of battery assemblies in the cooling fluid.
